(19) United States
(12) Patent Application Publication
(10) Pub. No.: US 2013/0033418 A1
(43) Pub. Date: Feb. 7, 2013

(54) GESTURE DETECTION USING PROXIMITY OR LIGHT SENSORS

(71) Applicants: Mathew William Bevilacqua, San Francisco, CA (US); Newfel Harrat, Burlingame, CA (US); Leonid Sheynblat, Hillsborough, CA (US)

(72) Inventors: Mathew William Bevilacqua, San Francisco, CA (US); Newfel Harrat, Burlingame, CA (US); Leonid Sheynblat, Hillsborough, CA (US)

(73) Assignee: QUALCOMM Incorporated, San Diego, CA (US)

(21) Appl. No.: 13/343,995

(22) Filed: Jan. 5, 2012

Related U.S. Application Data
(60) Provisional application No. 61/515,821, filed on Aug. 5, 2011.

(51) Int. Cl. G06F 3/033

(52) U.S. Cl. 345/156

(57) ABSTRACT

Example methods, apparatuses, or articles of manufacture are disclosed that may be utilized, in whole or in part, to facilitate or support one or more operations or techniques for gesture detection using, at least in part, output or measurement signals from one or more ambient environment sensors, such as, for example, a proximity sensor or ambient light sensor.

### CROSS-REFERENCE TO RELATED APPLICATIONS

The present application claims priority to U.S. Provisional Patent Application Ser. No. 61/515,821, entitled “GESTURE DETECTION USING PROXIMITY OR LIGHT SENSORS,” filed on Aug. 5, 2011, which is assigned to the assignee hereof and which is expressly incorporated herein by reference.

### BACKGROUND

1. Field

The present disclosure relates generally to motion sensing in mobile communication devices and, more particularly, to gesture detection using, at least in part, proximity or light sensors for use in or with mobile communication devices.

2. Information

Mobile communication devices, such as, for example, cellular telephones, digital audio or video players, portable navigation units, laptop computers, personal digital assistants, or the like are becoming more common every day. These devices may include, for example, a variety of sensors to support a number of applications in today's market. A popular market trend in sensor-based mobile technology may include, for example, applications that sense or recognize one or more aspects of a motion of a mobile communication device and use such aspects as a form of a user input. For example, certain applications may sense or recognize one or more informative hand or wrist gestures of a user and may use such gestures as inputs representing various user commands in selecting music, playing games, estimating a location, determining navigation route, browsing through digital maps or Web content, or the like.

Typically, although not necessarily, motion-based applications may utilize one or more motion sensors capable of converting physical phenomena into analog or digital signals. These sensors may be integrated into (e.g., built-in, etc.) or otherwise supported by (e.g., stand-alone, etc.) a mobile communication device and may detect a motion of the device by measuring, for example, the direction of gravity, intensity of a magnetic field, various vibrations, or the like. For example, a mobile communication device may feature one or more accelerometers, gyroscopes, magnetometers, gravitometers, or other sensors capable of detecting user-intended gestures by measuring various motion states, orientations, etc. of the device. In some instances, however, such as while a user is walking or running, for example, certain user-intended gestures may be more difficult to detect due to various incidental motions that may ordinarily exist in mobile settings or environments. Accordingly, how to detect user-intended gestures in environments that are more prone to false detections in an effective or efficient manner continues to be an area of development.

### BRIEF DESCRIPTION OF THE DRAWINGS

Non-limiting and non-exhaustive aspects are described with reference to the following figures, wherein like reference numerals refer to like parts throughout the various figures unless otherwise specified.

FIG. 1 is an example coordinate system that may be used to facilitate or support gesture detection of a mobile device in an implementation.

FIG. 2 is a flow diagram illustrating an example process for performing gesture detection using an ambient environment sensor, according to an implementation.

FIG. 3 is a graphical plot illustrating performance of a mobile device in connection with a condition applied to a measured level of acceleration, according to an implementation.

FIG. 4 is another flow diagram illustrating an example process for performing gesture detection using an ambient environment sensor, according to an implementation.

FIG. 5 is a schematic diagram illustrating an example computing environment associated with a mobile device, according to an implementation.

### SUMMARY

Example implementations relate to gesture detection using, at least in part, output or measurement signals from one or more ambient environment sensors. In one implementation, a method may comprise receiving, at a mobile device, at least one measurement from at least one inertial sensor indicative of motion of the mobile device; and selectively interpreting such a motion as a user-intended gesture based, at least in part, on at least one measurement from at least one ambient environment sensor correlated in time with the motion.

In another implementation, an apparatus may comprise a mobile device comprising at least one inertial sensor, at least one ambient environment sensor, and at least one processor to receive at least one measurement from at least one inertial sensor indicative of motion of the mobile device; and selectively interpret such a motion as a user-intended gesture based, at least in part, on at least one measurement from at least one ambient environment sensor correlated in time with the motion.

In yet another implementation, an apparatus may comprise means for receiving, at a mobile device, at least one measurement from at least one inertial sensor indicative of motion of the mobile device; and means for selectively interpreting such a motion as a user-intended gesture based, at least in part, on at least one measurement from at least one ambient environment sensor correlated in time with the motion.

In yet another implementation, an article may comprise a non-transitory storage medium having instructions stored thereon executable by a special purpose computing platform at a mobile device to receive at least one measurement from at least one inertial sensor indicative of motion of the mobile device; and selectively interpret such a motion as a user-intended gesture based, at least in part, on at least one measurement from at least one ambient environment sensor correlated in time with the motion.

In one particular implementation, at least one ambient environment sensors may comprise, for example, a proximity sensor or an ambient environment sensor disposed in the mobile device. It should be understood, however, that these are merely example implementations, and that claimed subject matter is not limited to these particular implementations.

### DETAILED DESCRIPTION

In the following detailed description, numerous specific details are set forth to provide a thorough understanding of claimed subject matter.

However, it will be understood by those skilled in the art that claimed subject matter may be practiced without these specific details. In other instances, methods, apparatuses, or systems that would be known by one of ordinary skill have not been described in detail so as not to obscure claimed subject matter.

Some example methods, apparatuses, or articles of manufacture are disclosed herein that may be implemented, in whole or in part, to facilitate or support one or more operations or techniques for gesture detection using, at least in part, output or measurement signals from one or more ambient environment sensors, such as, for example, a proximity sensor or ambient light sensor. As described below, output signals may be provided, in whole or in part, for use by a variety of applications, including, for example, motion-based applications hosted on a mobile communication device and offering motion-controlled solutions in connection with music selection, gaming, navigation, content browsing, or the like. As used herein, “mobile communication device,” “mobile device,” “portable device,” “hand-held device,” or the plural form of such terms may be used interchangeably and may refer to any kind of special purpose computing platform or device that may be capable of communicating through wireless transmission or receipt of information over suitable communications networks according to one or more communication protocols and that may from time to time have a position or location that changes. As a way of illustration, special purpose mobile communication devices, which may herein be called simply mobile devices, may include, for example, cellular telephones, satellite telephones, smart telephones, personal digital assistants (PDAs), laptop computers, portable entertainment systems, e-book readers, tablet personal computers (PC), hand-held audio or video players, personal navigation devices, or the like. It should be appreciated, however, that these are merely illustrative examples of mobile devices that may be utilized in connection with ambient environment sensor-supported gesture detection, and that claimed subject matter is not limited in this regard.

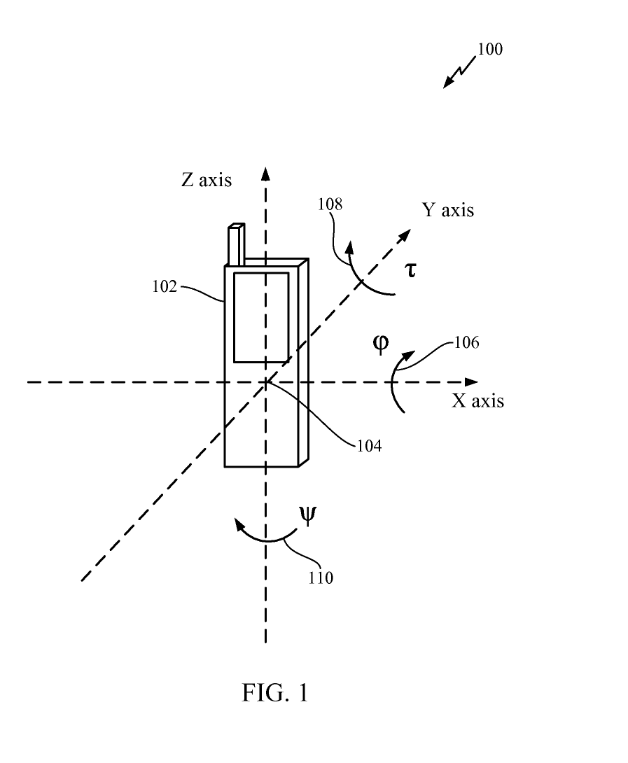

Following the above discussion, a mobile device may include, for example, a number of inertial or motion sensors, such as one or more accelerometers, gyroscopes, gravitometers, tilt sensors, magnetometers, or the like. These sensors, as well as other possible inertial sensors not listed, may be capable of providing signals for use by a variety of host applications, for example, while measuring various states of a mobile device using appropriate techniques. An accelerometer, for example, may sense a direction of gravity toward the center of the Earth and may detect or measure a motion with reference to one, two, or three directions often referenced in a Cartesian coordinate space as dimensions or axes X, Y, and Z. Optionally or alternatively, an accelerometer may also provide measurements of magnitude of various accelerations, for example. A direction of gravity may be measured in relation to any suitable frame of reference, such as, for example, in a coordinate system in which the origin or initial point of gravity vectors is fixed to or moves with a mobile device. An example coordinate system that may be used, in whole or in part, to facilitate or support one or more processes associated with user-intended gesture detection of a mobile device will be described in greater detail below in connection with FIG. 1. A gyroscope may utilize the Coriolis effect and may provide angular rate measurements in roll, pitch, or yaw dimensions and may be used, for example, in applications determining heading or azimuth changes. A magnetometer may measure the direction of a magnetic field in X, Y, Z dimensions and may be used, for example, in sensing true North or absolute heading in various navigation applications. It should be noted that these are merely examples of sensors that may be used, in whole or in part, to measure various states of a mobile device in connection with ambient environment sensor-supported gesture detection, and that claimed subject matter is not limited in this regard.

As was indicated, inertial or motion sensors may measure a level or magnitude of acceleration, angular changes about gravity, orientation or rotation, etc. experienced by a mobile device, just to name a few examples. Obtained measurement signals may be provided, for example, for use by a motion-controlled application interpreting user's hand or wrist gestures as inputs representative of user selections, commands, or other user-device interactions. By way of example, output signals from an accelerometer may be used, at least in part, by a music application interpreting informative gestures of a user in connection with selecting, fast forwarding, rewinding, or so-called shuffling music on a mobile device, just to illustrate one possible implementation. Inertial sensor signals, such as signals from an accelerometer or gyroscope, for example, may also be utilized by a navigation application interpreting user's gestures as instructions to determine an orientation of a mobile device relative to some reference frame, to estimate a location of a mobile device or navigation target, to suggest or confirm a navigation route, or the like. In addition, output signals from inertial sensors may be provided, at least in part, to facilitate or support various motion-controlled functionalities featured on a mobile device, for example, allowing a user to select or scroll through content of interest via an associated display. To illustrate, a user may employ informative gestures in connection with a motion-based application to zoom, pan, or browse through digital maps or Web content, to select suitable or desired options from various menus displayed on a screen or display of a mobile device, or the like. Of course, details relating to particular applications or functionalities that may be featured on a mobile device are merely examples, and claimed subject matter is not so limited.

At times, however, detecting or interpreting motion of a mobile device, for example, as a user-intended gesture in response to signals received or obtained from inertial sensors may present a number of challenges to users of these devices. As used herein, “motion” may refer to a physical displacement of an object, such as a mobile device, for example, relative to some frame of reference. As a way of illustration, a physical displacement may include, for example, changes in terms of an object's velocity, acceleration, position, orientation, or the like. As alluded to previously, challenges may include, for example, higher instances of false gesture detections due to various incidental motions or so-called background noise that may ordinarily exist in mobile settings or environments. For example, a user may carry or transport a mobile device in a pocket, purse, belt clip, carry case, armband, backpack, etc. while walking, running, being in a moving vehicle, or the like. In such an environment, inertial sensor signals may be unintentionally interpreted by an application as user-intended gesture inputs due to various incidental signals representative of, for example, vibrations, rotations, translations, etc. attributable to the user's concurrent walking, running, or the like. In other words, in mobile settings or environments, at times, a motion-based application may not be able to sufficiently distinguish or differentiate between a user-intended input gesture, such as while a mobile device is in the user's hand, for example, and incidental motion of the device being carried or transported in a purse, pocket, armband, or the like. Accordingly, it may be desirable to develop one or more methods, systems, or apparatuses that may implement informative or user-intended gesture detection in an effective or efficient manner, such as while a mobile device is in the user's hand, for example, rather than while the device is carried in a pocket, purse, backpack, or the like.

Thus, in an implementation, inertial sensor signals, such as output signals of an accelerometer, for example, may be correlated in some manner with signals obtained from one or more ambient environment sensors so as to facilitate or support user-intended gesture detection. For example, measurements of acceleration may be correlated in time with ambient environment sensor measurements, meaning that an ambient environment sensor may be sampled, at least in part, contemporaneously or at points in an interval during which a certain level of measured acceleration is detected or occurred. As will be described in greater detail below, one or more additional conditions may, for example, be considered in determining whether a motion detected via accelerometer measurement signals may be interpreted as a user-intended hand or wrist gesture input, just to illustrate one possible implementation. These one or more conditions may represent, for example, a certain state of a mobile device in an environment from which it may be inferred that detected acceleration is unlikely to be intended by a user as input gestures, such as while the mobile device is in a pocket, purse, armband, or the like. In other words, here, various measurements or combinations of measurements obtained or received from one or more ambient environment sensors may be used, at least in part, to determine a likelihood that particular acceleration being sensed is a result of an intentional gesture performed by a user while holding a mobile device. In some instances, a gesture detection functionality may, for example, be disabled, in whole or in part, if ambient environment sensor measurements indicate a condition where user-intended gestures are unlikely to occur, as will also be seen.

FIG. 1 illustrates an example coordinate system 100 that may be used, in whole or in part, to facilitate or support gesture detection of a mobile device, such as a mobile device 102, for example, using output signals of one or more inertial or motion sensors according to an implementation. As previously mentioned, inertial or motion sensors may include, for example, an accelerometer, gyroscope, gravitometer, tilt sensor, magnetometer, or the like, as previously mentioned. As illustrated, example coordinate system 100 may comprise, for example, three-dimensional Cartesian coordinate system, though claimed subject matter is not so limited. In this illustrated example, motion of mobile device 102 representing, for example, acceleration may be detected or measured, at least in part, by a suitable accelerometer, such as a 3D accelerometer, for example, with reference to three dimensions or axes X, Y, and Z relative to the origin 104 of example coordinate system 100. It should be appreciated that example coordinate system 100 may or may not be aligned with a body of mobile device 102. It should also be noted that in certain implementations a non-Cartesian coordinate system may be used or that a coordinate system may define dimensions that are mutually orthogonal.

A rotational motion of mobile device 102, such as orientation changes about gravity, for example, may also be detected or measured, at least in part, by a suitable accelerometer with reference to one or two dimensions. For example, in one particular implementation, rotational motion of mobile device 102 may be detected or measured in terms of coordinates (φ, τ), where phi (φ) represents roll or rotation about an X axis, as illustrated generally by arrow at 106, and tau (τ) represents pitch or rotation about an Y axis, as illustrated generally at 108. Accordingly, in an implementation, a 3D accelerometer may detect or measure, at least in part, a level of acceleration as well as a change about gravity with respect to roll or pitch dimensions, for example, thus, providing five dimensions of observability (X, Y, Z, φ, τ). It should be understood, however, that these are merely examples of various motions that may be detected or measured, at least in part, by an accelerometer with reference to example coordinate system 100, and that claimed subject matter is not limited to these particular motions or coordinate system.

As was also indicated, a rotational motion of a mobile device, such as mobile device 102, for example, may be detected or measured, at least in part, by a suitable gyroscope associated with mobile device 102 so as to provide adequate degrees of observability, just to illustrate another possible implementation. For example, a gyroscope may detect or measure rotational motion of mobile device 102 with reference to one, two, or three dimensions. Thus, in one particular implementation, gyroscopic rotation may, for example, be detected or measured, at least in part, in terms of coordinates (φ, τ, ψ), where phi (φ) represents roll or rotation 106 about an X axis, tau (T) represents pitch or rotation 108 about an Y axis, and psi (ψ) represents yaw or rotation about a Z axis, as referenced generally at 110. A gyroscope may typically, although not necessarily, provide measurements in terms of angular acceleration (e.g., a change in an angle per unit of time squared), angular velocity (e.g., a change in an angle per unit of time), or the like. Of course, details relating to various motions that may be detected or measured, at least in part, by a gyroscope with reference to example coordinate system 100 are merely examples, and claimed subject matter is not so limited. It should be appreciated that one or more operations or techniques described herein may be implemented, in whole or in part, in connection with a single-inertial-sensor or a multi-inertial-sensor mobile device, for example, capable of detecting or measuring motion with reference to one, two, or three dimensions.

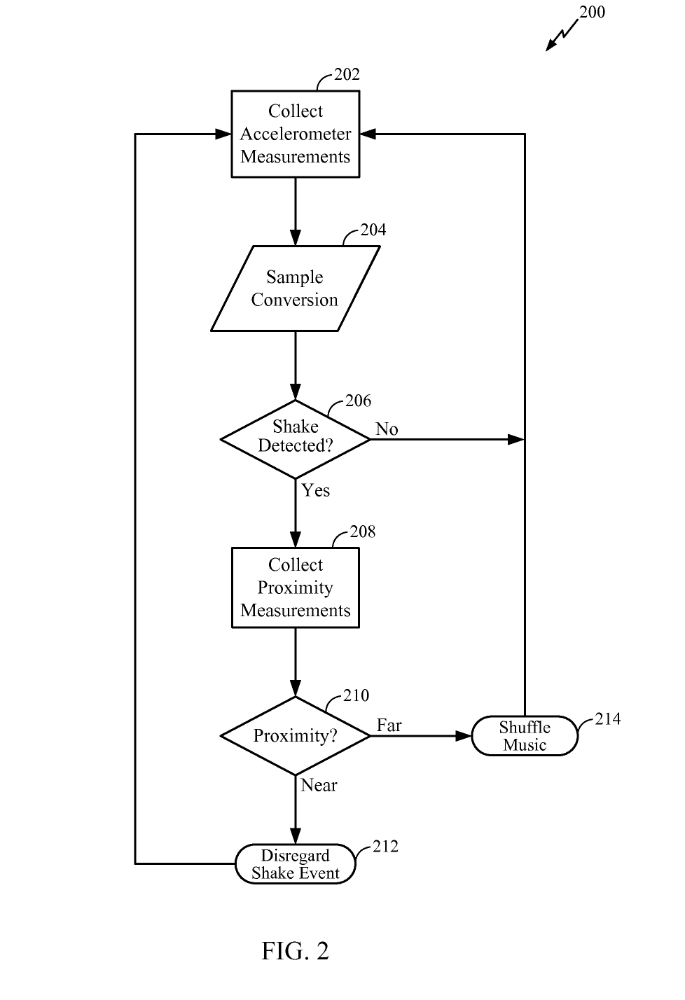

With this in mind, attention is drawn to FIG. 2, which is a flow diagram illustrating an implementation of an example process 200 for detecting user-intended input gestures using, at least in part, one or more ambient environment sensors. As illustrated, in one particular implementation, process 200 may be utilized, in whole or in part, in connection with a motion-based application for browsing or switching through (e.g., shuffling, etc.) music, though claimed subject matter is not so limited. Without loss of generality, process 200 may be representative of a scenario in which a user is browsing or switching through music while holding a mobile device in hand, for example, without necessarily looking at an associated screen or display. Having selected music via an input gesture and while the music is playing, for example, a user may place a mobile device in a pocket, purse, backpack, armband, etc. so as to listen to the music while running, walking, exercising, etc. without further user-device interaction (e.g., with display turned off, etc.). For this illustrated example, false gesture detections due to various incidental inertial sensor signals, as mentioned above, may be eliminated or reduced by utilizing measurement signals from an ambient environment sensor, such as a proximity sensor, for example. As will be described in greater detail below, in one particular implementation, a proximity sensor may, for example, be capable of performing a measurement activity or executing reports in a binary format indicative of far or near state or condition of a mobile device. For example, sensed acceleration may be interpreted as a user-intended input gesture if a proximity measurement exceeds some pre-defined threshold value, such as to report a far reading. Otherwise, if a proximity sensor reports a near reading, it may be inferred that sensed acceleration is unintentional or represents a background noise, in which case a gesture detection functionality may be disabled, as will also be seen.

More specifically, at operation 202, inertial sensor measurements, such as measurements with respect to a level of acceleration obtained or received via an accelerometer, for example, may be collected or otherwise monitored in some manner. A level of acceleration experienced by a mobile device may, for example, be measured and compared against some pre-defined acceleration threshold to infer or detect an informative or user-intended hand or wrist gesture-type motion, such as a shake. Such an acceleration threshold may be determined, at least in part, experimentally and may be pre-defined or configured, for example, or otherwise dynamically defined in some manner, depending on a particular application, environment, sensor, or the like. By way of example but not limitation, in one particular simulation or experiment, it appeared that an acceleration threshold of about 3.25 g may prove beneficial for informative gesture recognition in mobile settings or environments (e.g., walking, running, etc.), wherein g denotes the acceleration constant of 9.80665 meters per second squared (m/s²). Of course, details relating to an acceleration detection or acceleration threshold are merely examples to which claimed subject matter is not limited.

At operation 204, sample measurements with respect to a level of acceleration may be converted in some manner, for example, so as to arrive at a suitable or desired format. For example, rather than performing numerical computations with subsequent plotting of the resulting points, in one implementation, text-point representation-type format may be utilized, in whole or in part, so as to simplify processing or otherwise enhance performance. It should be appreciated, however, that claimed subject matter is not limited to such a format. It should also be noted that operation 204 may be optional in certain implementations or may be performed prior to or contemporaneously with operation 202.

At operation 206, a determination may be made regarding whether a shake has been detected or otherwise occurred, as previously mentioned. For example, if a measured level of acceleration is less than some pre-defined threshold, such as, for example, the threshold mentioned above, it may be determined or inferred that no shake has been detected or has occurred. In such a case, a process may return to operation 202 for further collecting or monitoring of inertial sensor measurements, such as measurements with respect to a level of acceleration, for example.

On the other hand, if a shake has been detected or occurred, such as if a measured level of acceleration exceeds some threshold, such as, for example, the threshold mentioned above, then, at operation 208, ambient environment sensor measurements may be collected or otherwise obtained in some manner. For example, in one particular implementation, ambient environment sensor measurements may be collected or obtained via a proximity sensor, though claimed subject matter is not so limited. Typically, although not necessarily, a proximity sensor may, for example, detect a presence of nearby objects, measure a distance to such objects, etc. without physical contact. Proximity sensors may, for example, be featured on a mobile device, such as to turn off a display while not in use, deactivate a touch screen to avoid input during a call, or the like. In one particular implementation, a proximity sensor may be realized, for example, as an infrared (IR) emitter-receiver pair placed sufficiently closely together on a mobile device. For this example, a proximity sensor may emit (e.g., via a light emitting diode (LED), etc.) a beam of IR light and a reflected light from a nearby object may be converted into current or digitized so as to allow for a measurement activity, such as, for example, to determine a distance to the object, as previously mentioned. Proximity sensors are known and need not be described here in greater detail.

With regard to operation 210, collected or otherwise obtained proximity sensor measurements may be utilized or otherwise considered, in whole or in part, as an additional condition in determining whether a motion sensed via accelerometer measurements may be interpreted as a user-intended or informative input gesture. As previously mentioned, such a condition may be associated with an environment in which user-intended gestures are more likely to occur, such as, for example, while the device is in the user's hand. By way of example but not limitation, in certain simulations or experiments, it has been observed that typically, although not necessarily, a user may be less likely to perform an input gesture while a mobile device is in sufficiently close proximity to or near some obstacle or object. Such an object may include, for example, the user's leg or chest, such as while the device is in a pocket, etc., the user's arm, such as while the device is in an armband, etc., side wall or divider, such as while the device is in a user's purse, backpack, etc., or the like. In other words, it appeared that sensed acceleration of a mobile device, such as a shake, for example, is less likely to be intended as a user-intended gesture input if measurements from a proximity sensor indicate that the mobile device is near some object. Accordingly, proximity sensor measurements reporting a near reading may, for example, indicate that a mobile device is in a pocket, purse, backpack, etc. and, as such, may be interpreted as a condition where user-intended gestures are less likely to occur, notwithstanding some level of acceleration. In such a case, an invalid or falsely detected gesture corresponding to an unintentional input may be declared, for example. If, on the other hand, proximity sensor measurements report a condition corresponding to a far reading, sensed acceleration may be interpreted as an intentional input gesture by a user and may be acted upon accordingly (e.g., perform user command, selection, etc.).

Following the above discussion, proximity sensor measurements may be compared against some pre-defined proximity threshold to establish, for example, one or more additional conditions of a mobile device, such as conditions corresponding to a near or far sensor readings. For example, in one particular implementation, a proximity sensor may be adapted, configured to, or otherwise be capable of reporting a distance to a nearby object in a binary manner, such as either exceeding or falling below a certain pre-defined proximity threshold, as was indicated. Here, one or more proximity sensor measurements, correlated in time with sensed acceleration or otherwise, which exceed such a threshold may, for example, correspond to a far reading of a proximity sensor. Likewise, one or more proximity sensor measurements, correlated in time with sensed acceleration or otherwise, which fall below a certain threshold, for example, may correspond to a near reading. A proximity threshold may be determined, at least in part, experimentally and may be pre-defined or configured, for example, or otherwise dynamically defined in some manner, depending on a particular application, environment, sensor, or the like. By way of example but not limitation, in one particular simulation or experiment, it appeared that a proximity threshold of 10.0 millimeters may prove beneficial in handling gesture detection in connection, for example, with a condition applied to a measured level of acceleration. Of course, this is merely an example of a proximity threshold that may be used, at least in part, in connection with informative gesture detection, and claimed subject matter is not limited in this regard.

Accordingly, here, if a proximity sensor reports or indicates a near reading, for example, it may be inferred that a detected gesture (e.g., a shake, etc.) is unintentional and, as such, may be disregarded or ignored, as indicated generally at operation 212. In other words, a gesture detection functionality of a mobile device may, for example, be disabled if a proximity sensor indicates a condition under which user-intended gestures are less likely to occur, as previously mentioned. In such a case, a process may return to operation 202 for further collecting or monitoring of inertial sensor measurements, such as measurements with respect to a level of acceleration, for example. If, however, a proximity sensor reports a far reading, then a gesture may be declared valid, meaning that particular acceleration (e.g., a shake, etc.) being sensed is more likely occurred as a result of an intentional gesture by a user. Here, a process may use such a gesture as a form of input representative, for example, of a user command or selection (e.g., shuffling music, etc.), as indicated generally at operation 214. As also illustrated, having performed a particular user command or selection, example process 200 may, for example, return to operation 202 to be repeated, in whole or in part, if desired.

It should be appreciated that even though the utilization of a proximity sensor is illustrated at operations 208 through 214, for example, any suitable or desired type or number of ambient environment sensors may be employed herein. To illustrate, in certain implementations, an ambient light sensor may, for example, be utilized, in whole or in part, to facilitate or support one or more operations associated with example process 200. Typically, although not necessarily, an ambient light sensor may, for example, measure an increase in luminous intensity of the ambient light in terms of illuminance (e.g., for light incident on a surface) or luminous emittance (e.g., for light emitted from a surface) in counts of [lux] in SI photometry units. Certain implementations of a mobile device may, for example, feature an ambient light sensor to help in adjusting a touch screen backlighting, to enhance visibility of a display, etc. in a dimly lit environment, or the like. In one particular implementation, an ambient light sensor may be realized, for example, as a photodiode or array of photodiodes converting ambient light into current so as to allow for measurements of luminous intensity at a mobile device, though claimed subject matter is not so limited. Ambient light sensors are known and need not be described here in greater detail.

Thus, measurement signals collected or otherwise obtained from an ambient light sensor may be used, at least in part, at operations 208 through 214, for example, in a fashion similar to an implementation utilizing a proximity sensor, as discussed above. For example, a measured level of a luminous intensity may be compared against some pre-defined ambient light threshold so as to establish one or more additional conditions of a mobile device, such as conditions corresponding to a near or far sensor readings. Similarly, here, ambient light sensor measurements reporting a near reading may, for example, indicate that a mobile device is in a darker environment, such as in a pocket, purse, armband, etc. and, as such, may be interpreted as a condition where user-intended gestures are less likely to occur, notwithstanding some level of sensed acceleration. Accordingly, in such a case, a shake may be declared as an unintentional or falsely detected gesture and, thus, may be disregarded or otherwise ignored. If, however, an ambient light sensor reports a far reading, it may be inferred, for example, that particular acceleration being sensed is more likely a result of an intentional gesture performed by a user while holding a mobile device in hand (e.g., in a brighter environment, etc.).

Likewise, here, an ambient light threshold may be determined, at least in part, experimentally and may be pre-defined or configured, for example, or otherwise dynamically defined in some manner, depending on a particular application, environment, sensor, or the like. By way of example but not limitation, in certain simulations or experiments, such as in an outdoor environment, for example, an ambient light threshold of about 700 lux was used, such that a luminous intensity of the ambient light greater than 700 lux would correspond to a far reading, and measurements below such a threshold would correspond to a near reading. With respect to an indoor environment, an ambient light threshold of about 10 lux may, for example, prove beneficial in distinguishing between a mobile device being in a pocket, purse, backpack, etc. and being uncovered, such as in hand, for example. At times, a mobile device may determine whether an associated user is indoors or outdoors by utilizing one or more appropriate techniques, such as via measuring signal strengths from suitable WiFi, GPS, or like devices, as one possible example. In some instances, such as at night, for example, an ambient light threshold may be defined or configured so as to account for one or more appropriate natural or artificial lighting levels, such as, for example, a pedestrian walkway lighting level (e.g., typically in a range between 1-15 lux, etc.), moon lighting level (e.g., a full moon is typically about 1 lux, etc.), or the like. Of course, these are merely examples of thresholds that may prove beneficial in handling gesture detection in connection, for example, with a condition applied to a measured level of acceleration, and claimed subject matter is not so limited in scope.

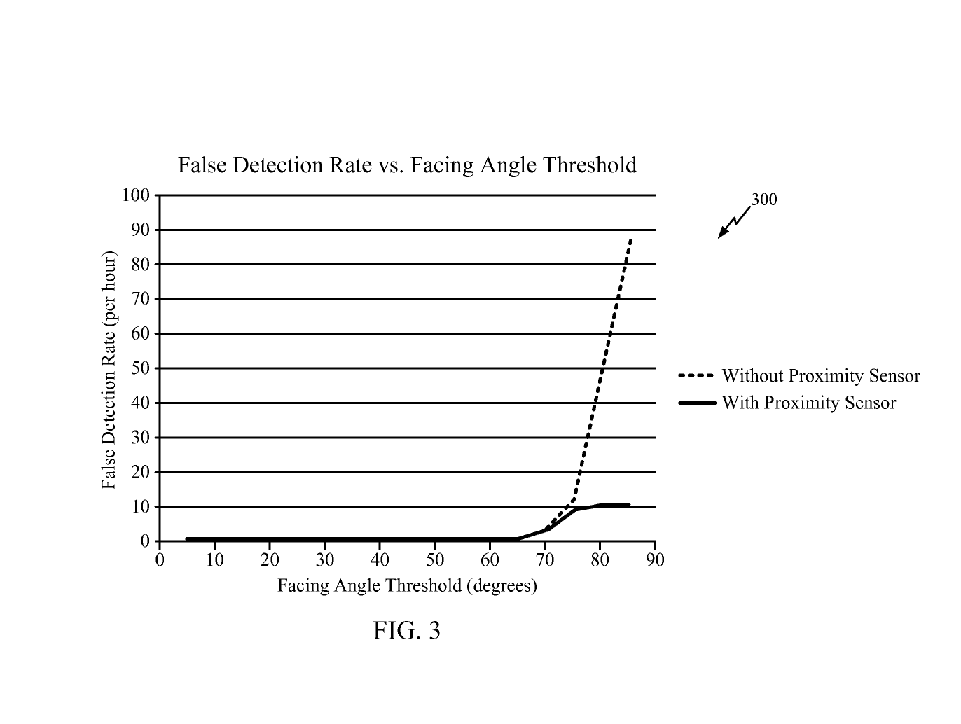

FIG. 3 is a graphical plot 300 illustrating performance of a mobile device in connection with a condition applied to a measured level of acceleration, for example, if false detection rates are evaluated against facing angle thresholds. Here, certain facing angle thresholds, such as thresholds in a range between 70 and 90 degrees may, for example, be representative of instances or situations in which a mobile device is being carried or transported in a pocket, purse, armband, or the like, rather than in the user's hand. As seen, statistically significant improvement in performance using measurement signals collected or otherwise obtained from an ambient environment sensor, such as a proximity sensor, for example, appears to be achieved. More specifically, it appears that a statistically significant number of false detections of input gestures occurring between 70 and 90 degrees, for example, may be eliminated or otherwise reduced by utilizing, at least in part, proximity sensor measurements. Accordingly, here, a facing angle threshold may be advantageously increased or opened up so as to allow for sufficiently accurate gesture detection in mobile settings or environments. It should be noted that false detection rates, facing angle thresholds, as well as graphical plots shown are merely examples to which claimed subject matter is not limited.

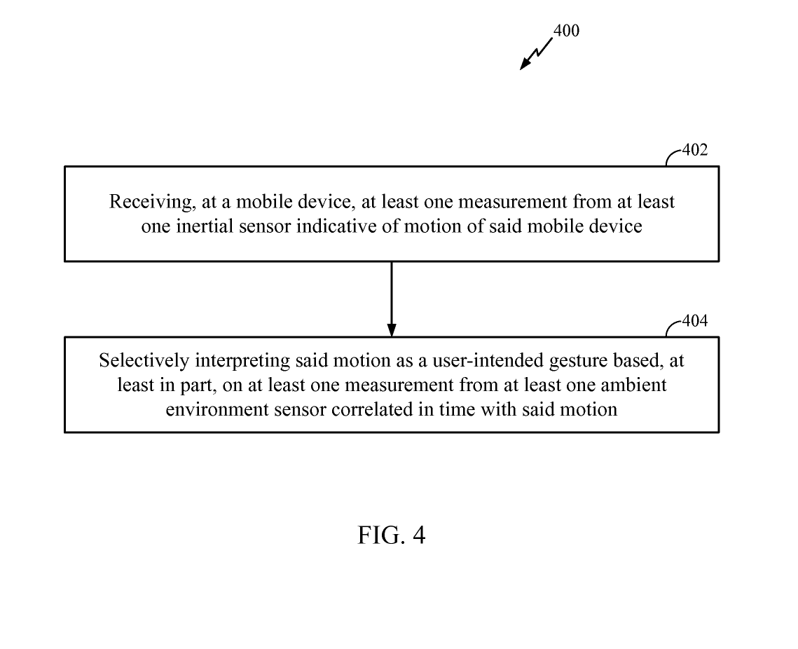

Referring now to FIG. 4, which is a flow diagram illustrating an implementation of an example process 400 that may be implemented, in whole or in part, to detect an informative or intentional gesture of a user using, for example, output or measurement signals from one or more ambient environment sensors. It should be appreciated that even though one or more operations are illustrated or described concurrently or with respect to a certain sequence, other sequences or concurrent operations may also be employed. In addition, although the description below references particular aspects or features illustrated in certain other figures, one or more operations may be performed with other aspects or features.

Example process 400 may begin at operation 402, for example, with receiving, at a mobile device, at least one measurement from at least one inertial sensor indicative of motion of such a mobile device. For example, at least one inertial sensor measurement, such as a measurement with respect to a level of acceleration may be received or obtained from an accelerometer disposed in a mobile device, though claimed subject matter is not so limited. As previously mentioned, a level of acceleration experienced by a mobile device may, for example, be representative of one or more translational, rotational, or like motions and may be measured and compared against some pre-defined acceleration threshold to infer or detect a hand or wrist gesture-type motion, such as a shake. In some instances, if a measured level of acceleration is less than some pre-defined threshold, for example, it may be inferred that no shake has occurred. Otherwise, if such measurements exceed the threshold, a mobile device may infer motion.

With regard to operation 404, sensed motion may be selectively interpreted as a user-intended gesture based, at least in part, on at least one measurement from at least one ambient environment sensor correlated in time with the motion. For example, at least one inertial-based measurement, such as a measurement of acceleration may be correlated in time with an ambient environment sensor measurement by sampling an ambient environment sensor, at least in part, at points in an interval during which a certain level of measured acceleration is detected or occurred. Various measurements obtained or received from one or more ambient environment sensors may be used, at least in part, as one or more conditions to determine a likelihood that particular motions being sensed are a result of an intentional gesture performed by a user while holding a mobile device. Although claimed subject matter is not limited in this respect, a proximity sensor or ambient light sensor may be utilized, at least in part, to establish or detect such one or more conditions, just to name a few examples. Sensed acceleration may be interpreted as a user-intended input gesture if, for example, at least one ambient environment sensor measurement exceeds some pre-defined threshold to report a far reading. As such, sensed acceleration may be selectively interpreted as a user-intended gesture by inferring, for example, that a mobile device is in a user's hand contemporaneously with such acceleration. Otherwise, if a proximity sensor reports a near reading, for example, it may be inferred that sensed acceleration is unintentional or represents a background noise. A gesture detection functionality associated with a mobile device may then be disabled accordingly, as previously mentioned.

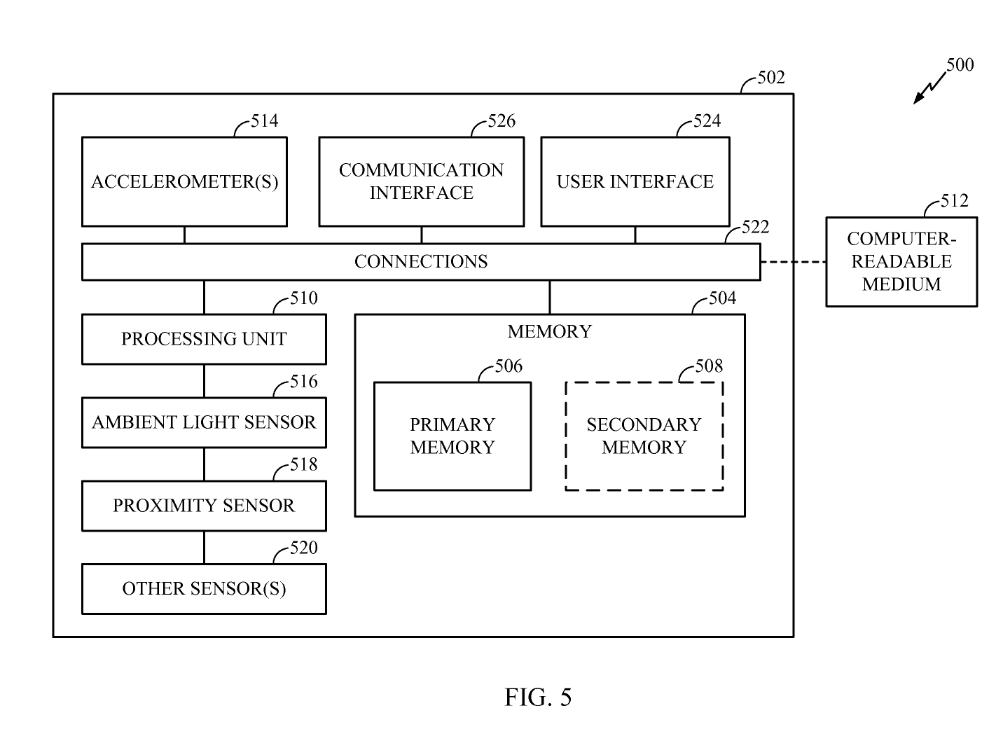

FIG. 5 is a schematic diagram illustrating an implementation of an example computing environment 500 that may include one or more networks or devices capable of partially or substantially implementing or supporting one or more processes for gesture detection using, at least in part, output or measurement signals from one or more ambient environment sensors, such as, for example, a proximity sensor or ambient light sensor. It should be appreciated that all or part of various devices or networks shown in computing environment 500, processes, or methods, as described herein, may be implemented using various hardware, firmware, or any combination thereof along with software.

Computing environment 500 may include, for example, a mobile device 502, which may be communicatively coupled to any number of other devices, mobile or otherwise, via a suitable communications network, such as a cellular telephone network, the Internet, mobile ad-hoc network, wireless sensor network, or the like. In an implementation, mobile device 502 may be representative of any electronic device, appliance, or machine that may be capable of exchanging information over any suitable communications network. For example, mobile device 502 may include one or more computing devices or platforms associated with, for example, cellular telephones, satellite telephones, smart telephones, personal digital assistants (PDAs), laptop computers, personal entertainment systems, e-book readers, tablet personal computers (PC), personal audio or video devices, personal navigation devices, or the like. In certain example implementations, mobile device 502 may take the form of one or more integrated circuits, circuit boards, or the like that may be operatively enabled for use in another device. Thus, unless stated otherwise, to simplify discussion, various functionalities, elements, components, etc. are described below with reference to mobile device 502 may also be applicable to other devices not shown so as to support one or more processes associated with example computing environment 500.

Although not shown, optionally or alternatively, there may be additional devices, mobile or otherwise, communicatively coupled to mobile device 502 to facilitate or otherwise support one or more processes associated with computing environment 500. For example, computing environment 500 may include various computing or communication resources capable of providing position or location information with regard to a mobile device 502 based, at least in part, on one or more wireless signals associated with a positioning system, location-based service, or the like. To illustrate, in certain example implementations, mobile device 502 may include, for example, a location-aware or tracking unit capable of acquiring or providing all or part of orientation, position information. Such information may be provided in support of one or more processes in response to user instructions, motion-controlled or otherwise, which may be stored in memory 504, for example, along with other suitable or desired information, such as one or more threshold values (e.g., corresponding to a “near,” far readings, etc.), or the like.

Memory 504 may represent any suitable or desired information storage medium. For example, memory 504 may include a primary memory 506 and a secondary memory 508. Primary memory 506 may include, for example, a random access memory, read only memory, etc. While illustrated in this example as being separate from a processing unit 510, it should be appreciated that all or part of primary memory 506 may be provided within or otherwise co-located/coupled with processing unit 510. Secondary memory 508 may include, for example, the same or similar type of memory as primary memory or one or more information storage devices or systems, such as, for example, a disk drive, an optical disc drive, a tape drive, a solid state memory drive, etc. In certain implementations, secondary memory 508 may be operatively receptive of, or otherwise enabled to be coupled to, a computer-readable medium 512.

It should be understood that a storage medium may typically, although not necessarily, be non-transitory or may comprise a non-transitory device. In this context, a non-transitory storage medium may include, for example, a device that is physical or tangible, meaning that the device has a concrete physical form, although the device may change state. For example, one or more electrical binary digital signals representative of information, in whole or in part, in the form of zeros may change a state to represent information, in whole or in part, as binary digital electrical signals in the form of ones, to illustrate one possible implementation. As such, “non-transitory” may refer, for example, to any medium or device remaining tangible despite this change in state.

Computer-readable medium 512 may include, for example, any medium that can store or provide access to information, code or instructions (e.g., an article of manufacture, etc.) for one or more devices associated with operating environment 500. For example, computer-readable medium 512 may be provided or accessed by processing unit 510. As such, in certain example implementations, the methods or apparatuses may take the form, in whole or part, of a computer-readable medium that may include computer-implementable instructions stored thereon, which, if executed by at least one processing unit or other like circuitry, may enable processing unit 510 or the other like circuitry to perform all or portions of a location determination processes, sensor-based or sensor-supported measurements (e.g., acceleration, deceleration, orientation, tilt, rotation, distance, luminous intensity, etc.) or any like processes to facilitate or otherwise support gesture detection of mobile device 502. In certain example implementations, processing unit 510 may be capable of performing or supporting other functions, such as communications, music shuffling, gaming, or the like.

Processing unit 510 may be implemented in hardware or a combination of hardware and software. Processing unit 510 may be representative of one or more circuits capable of performing at least a portion of information computing technique or process. By way of example but not limitation, processing unit 510 may include one or more processors, controllers, microprocessors, microcontrollers, application specific integrated circuits, digital signal processors, programmable logic devices, field programmable gate arrays, or the like, or any combination thereof.

Mobile device 502 may include various components or circuitry, such as, for example, one or more accelerometers 514, ambient light sensors 516, proximity sensors 518, or various other sensor(s) 520, such as a gyroscope, magnetometer, gravitometer, tilt sensor, etc. to facilitate or otherwise support one or more processes associated with operating environment 500. For example, such sensors may provide analog or digital signals to processing unit 510. Although not shown, it should be noted that mobile device 502 may include an analog-to-digital converter (ADC) for digitizing analog signals from one or more sensors. Optionally or alternatively, such sensors may include a designated (e.g., an internal, etc.) ADC(s) to digitize respective output signals, although claimed subject matter is not so limited.

Although not shown, mobile device 502 may also include a memory or information buffer to collect suitable or desired information, such as, for example, inertial or ambient environment sensor measurement information, and a power source to provide power to some or all of the components or circuitry. A power source may be a portable power source, such as a battery, for example, or may comprise a fixed power source, such as an outlet (e.g. in a house, electric charging station, car, etc.). It should be appreciated that a power source may be integrated into (e.g., built-in, etc.) or otherwise supported by (e.g., stand-alone, etc.) mobile device 502.

Mobile device 502 may include one or more connections 522 (e.g., buses, lines, conductors, optic fibers, etc.) to operatively couple various circuits together, and a user interface 524 (e.g., display, touch screen, keypad, buttons, knobs, microphone, speaker, trackball, data port, etc.) to receive user input, facilitate or support sensor measurements, or provide information to a user. Mobile device 502 may further include a communication interface 526 (e.g., wireless transmitter or receiver, modem, antenna, etc.) to allow for communication with one or more other devices or systems over one or more suitable communications networks, as was indicated.

Methodologies described herein may be implemented by various means depending upon applications according to particular features or examples. For example, such methodologies may be implemented in hardware, firmware, software, discrete/fixed logic circuitry, any combination thereof, and so forth. In a hardware or logic circuitry implementation, for example, a processing unit may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other devices or units designed to perform the functions described herein, or combinations thereof, just to name a few examples.

For a firmware or software implementation, the methodologies may be implemented with modules (e.g., procedures, functions, etc.) having instructions that perform the functions described herein. Any machine readable medium tangibly embodying instructions may be used in implementing the methodologies described herein. For example, software codes may be stored in a memory and executed by a processor. Memory may be implemented within the processor or external to the processor. As used herein the term “memory” refers to any type of long term, short term, volatile, nonvolatile, or other memory and is not to be limited to any particular type of memory or number of memories, or type of media upon which memory is stored. In at least some implementations, one or more portions of the herein described storage media may store signals representative of data or information as expressed by a particular state of the storage media. For example, an electronic signal representative of data or information may be “stored” in a portion of the storage media (e.g., memory) by affecting or changing the state of such portions of the storage media to represent data or information as binary information (e.g., ones and zeros). As such, in a particular implementation, such a change of state of the portion of the storage media to store a signal representative of data or information constitutes a transformation of storage media to a different state or thing.

As was indicated, in one or more example implementations, the functions described may be implemented in hardware, software, firmware, discrete/fixed logic circuitry, some combination thereof, and so forth. If implemented in software, the functions may be stored on a physical computer-readable medium as one or more instructions or code. Computer-readable media include physical computer storage media. A storage medium may be any available physical medium that can be accessed by a computer. By way of example, and not limitation, such computer-readable media can comprise RAM, ROM, EEPROM, CD-ROM or other optical disc storage, magnetic disk storage or other magnetic storage devices, or any other medium that can be used to store desired program code in the form of instructions or data structures and that can be accessed by a computer or processor thereof. Disk and disc, as used herein, includes compact disc (CD), laser disc, optical disc, digital versatile disc (DVD), floppy disk and blue-ray disc where disks usually reproduce data magnetically, while discs reproduce data optically with lasers.

As discussed above, a mobile device may be capable of communicating with one or more other devices via wireless transmission or receipt of information over various communications networks using one or more wireless communication techniques. Here, for example, wireless communication techniques may be implemented using a wireless wide area network (WWAN), a wireless local area network (WLAN), a wireless personal area network (WPAN), or the like. The term “network” and “system” may be used interchangeably herein. A WWAN may be a Code Division Multiple Access (CDMA) network, a Time Division Multiple Access (TDMA) network, a Frequency Division Multiple Access (FDMA) network, an Orthogonal Frequency

Division Multiple Access (OFDMA) network, a Single-Carrier Frequency Division Multiple Access (SC-FDMA) network, a Long Term Evolution (LTE) network, a WiMAX (IEEE 802.16) network, and so on. A CDMA network may implement one or more radio access technologies (RATs) such as cdma2000, Wideband-CDMA (W-CDMA), Time Division Synchronous Code Division Multiple Access (TD-SCDMA), to name just a few radio technologies. Here, cdma2000 may include technologies implemented according to IS-95, IS-2000, and IS-856 standards. A TDMA network may implement Global System for Mobile Communications (GSM), Digital Advanced Mobile Phone System (D-AMPS), or some other RAT. GSM and W-CDMA are described in documents from a consortium named “3rdGeneration Partnership Project” (3GPP). Cdma2000 is described in documents from a consortium named “3rd Generation Partnership Project 2” (3GPP2). 3GPP and 3GPP2 documents are publicly available. A WLAN may include an IEEE 802.11x network, and a WPAN may include a Bluetooth network, an IEEE 802.15x, or some other type of network, for example. The techniques may also be implemented in conjunction with any combination of WWAN, WLAN, or WPAN. Wireless communication networks may include so-called next generation technologies (e.g., “4G”), such as, for example, Long Term Evolution (LTE), Advanced LTE, WiMAX, Ultra Mobile Broadband (UMB), or the like.

In one particular implementation, a mobile device may, for example, be capable of communicating with one or more femtocells facilitating or supporting communications with the mobile device for the purpose of estimating its location, orientation, velocity, acceleration, or the like. As used herein, “femtocell” may refer to one or more smaller-size cellular base stations that may be enabled to connect to a service provider's network, for example, via broadband, such as, for example, a Digital Subscriber Line (DSL) or cable. Typically, although not necessarily, a femtocell may utilize or otherwise be compatible with various types of communication technology such as, for example, Universal Mobile Telecommunications System (UTMS), Long Term Evolution (LTE), Evolution-Data Optimized or Evolution-Data only (EV-DO), GSM, Worldwide Interoperability for Microwave Access (WiMAX), Code division multiple access (CDMA)-2000, or Time Division Synchronous Code Division Multiple Access (TD-SCDMA), to name just a few examples among many possible. In certain implementations, a femtocell may comprise integrated WiFi, for example. However, such details relating to femtocells are merely examples, and claimed subject matter is not so limited.

Also, computer-readable code or instructions may be transmitted via signals over physical transmission media from a transmitter to a receiver (e.g., via electrical digital signals). For example, software may be transmitted from a website, server, or other remote source using a coaxial cable, fiber optic cable, twisted pair, digital subscriber line (DSL), or physical components of wireless technologies such as infrared, radio, or microwave. Combinations of the above may also be included within the scope of physical transmission media. Such computer instructions or data may be transmitted in portions (e.g., first and second portions) at different times (e.g., at first and second times). Some portions of this Detailed Description are presented in terms of algorithms or symbolic representations of operations on binary digital signals stored within a memory of a specific apparatus or special purpose computing device or platform. In the context of this particular Specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared, or otherwise manipulated.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussions utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

While certain example techniques have been described and shown herein using various methods or systems, it should be understood by those skilled in the art that various other modifications may be made, and equivalents may be substituted, without departing from claimed subject matter. Additionally, many modifications may be made to adapt a particular situation to the teachings of claimed subject matter without departing from the central concept described herein. Therefore, it is intended that claimed subject matter not be limited to particular examples disclosed, but that such claimed subject matter may also include all implementations falling within the scope of the appended claims, and equivalents thereof.

What is claimed is:

1. A method comprising:
receiving, at a mobile device, at least one measurement from at least one inertial sensor indicative of motion of said mobile device; and
selectively interpreting said motion as a user-intended gesture based, at least in part, on at least one measurement from at least one ambient environment sensor correlated in time with said motion.

2. The method of claim 1, wherein said selectively interpreting said motion as said user-intended gesture comprises inferring that said mobile device is in a user's hand contemporaneously with said at least one measurement from said at least one inertial sensor based, at least in part, on said at least one measurement from said at least one ambient environment sensor.

3. The method of claim 1, wherein said at least one ambient environment sensor comprises at least one of the following: a proximity sensor disposed in said mobile device; an ambient light sensor disposed in said mobile device; or any combination thereof.

4. The method of claim 1, wherein said at least one inertial sensor comprises at least one of the following: an accelerometer disposed in said mobile device; a gyroscope disposed in said mobile device; or any combination thereof.

5. The method of claim 1 further comprising disabling a gesture detection functionality of said mobile device in response to said at least one measurement from said at least one ambient environment sensor.

6. The method of claim 5, wherein said disabling said gesture detection functionality further comprises:
detecting a condition where said user-intended gesture is less likely to occur; and
declaring said gesture to be a falsely detected gesture based, at least in part, on said condition.

7. The method of claim 6, wherein said condition is based, at least in part, on said at least one measurement from said at least one ambient environment sensor corresponding to a near reading of said at least one ambient environment sensor.

8. The method of claim 6 further comprising disregarding said falsely detected gesture to further receive said at least one measurement from said at least one inertial sensor for said selectively interpreting said motion as said user-intended gesture.

9. The method of claim 1, wherein said selectively interpreting said motion as said user-intended gesture further comprises:
detecting a condition applied to a measured level of acceleration; and
determining whether said condition corresponds to at least one of the following: a near reading of said at least one ambient environment sensor; a far reading of said at least one ambient environment sensor; or any combination thereof.

10. The method of claim 1, wherein said motion comprises a shake initiating at least one process in connection with said mobile device.

11. The method of claim 10, wherein said at least one process comprises a gesture detection-related process.

12. The method of claim 10, wherein said at least one process comprises an ambient environment sensor-supported gesture detection process.

13. An apparatus comprising:
a mobile device comprising at least one inertial sensor, at least one ambient environment sensor, and at least one processor configured to:
receive at least one measurement from said at least one inertial sensor indicative of motion of said mobile device; and
selectively interpret said motion as a user-intended gesture based, at least in part, on at least one measurement from said at least one ambient environment sensor correlated in time with said motion.

14. The apparatus of claim 13, wherein said at least one processor configured to selectively interpret said motion as said user-intended gesture is further configured to infer that said mobile device is in a user's hand contemporaneously with said at least one measurement from said at least one inertial sensor based, at least in part, on said at least one measurement from said at least one ambient environment sensor.

15. The apparatus of claim 13, wherein said at least one ambient environment sensor comprises at least one of the following: a proximity sensor disposed in said mobile device; an ambient light sensor disposed in said mobile device; or any combination thereof.

16. The apparatus of claim 13, wherein said at least one processor is further configured to disable a gesture detection functionality of said mobile device in response to said at least one measurement from said at least one ambient environment sensor.

17. The apparatus of claim 16, wherein said at least one processor configured to disable said gesture detection functionality is further configured to:
detect a condition where said user-intended gesture is less likely to occur; and
declare said gesture to be a falsely-detected gesture based, at least in part, on said condition.

18. An apparatus comprising:
means for receiving, at a mobile device, at least one measurement from at least one inertial sensor indicative of motion of said mobile device; and
means for selectively interpreting said motion as a user-intended gesture based, at least in part, on at least one measurement from at least one ambient environment sensor correlated in time with said motion.

19. The apparatus of claim 18, wherein said means for selectively interpreting said motion as said user-intended gesture comprises means for inferring that said mobile device is in a user's hand contemporaneously with said at least one measurement from said at least one inertial sensor based, at least in part, on said at least one measurement from said at least one ambient environment sensor.

20. The apparatus of claim 18, wherein said at least one ambient environment sensor comprises at least one of the following: a proximity sensor disposed in said mobile device; an ambient light sensor disposed in said mobile device; or any combination thereof.

21. The apparatus of claim 18, wherein said at least one inertial sensor comprises at least one of the following: an accelerometer disposed in said mobile device; a gyroscope disposed in said mobile device; or any combination thereof.

22. The apparatus of claim 18 further comprising means for disabling a gesture detection functionality of said mobile device in response to said at least one measurement from said at least one ambient environment sensor.

23. The apparatus of claim 22, wherein said means for disabling said gesture detection functionality further comprises:
means for detecting a condition where said user-intended gesture is less likely to occur; and
means for declaring said gesture to be a falsely detected gesture based, at least in part, on said condition.

24. The apparatus of claim 23, wherein said condition is based, at least in part, on said at least one measurement from said at least one ambient environment sensor corresponding to a near reading of said at least one ambient environment sensor.

25. The apparatus of claim 23 further comprising means for disregarding said falsely detected gesture to further receive said at least one measurement from said at least one inertial sensor for said selectively interpreting said motion as said user-intended gesture.

26. The apparatus of claim 18, wherein said means for selectively interpreting said motion as said user-intended gesture comprises:
means for detecting a condition applied to a measured level of acceleration; and
means for determining whether said condition corresponds to at least one of the following: a near reading of said at least one ambient environment sensor; a far reading of said at least one ambient environment sensor; or any combination thereof.

27. An article comprising:
a non-transitory storage medium having instructions stored thereon executable by a special purpose computing platform at a mobile device to:
receive at least one measurement from at least one inertial sensor indicative of motion of said mobile device; and
selectively interpret said motion as a user-intended gesture based, at least in part, on at least one measurement from at least one ambient environment sensor correlated in time with said motion.

28. The article of claim 27, wherein said instructions to selectively interpret said motion as said user-intended gesture further comprises instructions to infer that said mobile device is in a user's hand contemporaneously with said at least one measurement from said at least one inertial sensor based, at least in part, on said at least one measurement from said at least one ambient environment sensor.

29. The article of claim 27, wherein said storage medium further comprises instructions to disable a gesture detection functionality of said mobile device in response to said at least one measurement from said at least one ambient environment sensor.

30. The article of claim 29, wherein said instructions to disable said gesture detection functionality further comprises instructions to:
detect a condition where said user-intended gesture is less likely to occur; and
declare said gesture to be a falsely detected gesture based, at least in part, on said condition.

31. The article of claim 27, wherein said at least one ambient environment sensor comprises at least one of the following: a proximity sensor disposed in said mobile device; an ambient light sensor disposed in said mobile device; or any combination thereof.
